(19) United States
(12) Patent Application Publication
(10) Pub. No.: US 2006/0282516 A1
(43) Pub. Date: Dec. 14, 2006

(54) System and method for discovering component applications

(76) Inventors: Sean Paul Taylor, Milton (CA); Viera Bibr, Kilbride (CA); Brindusa Fritsch, Toronto (CA); Michael Shenfield, Richmond Hill (CA)

Correspondence Address: Gowling Lafleur Henderson LLP, 2600-160 Elgin Street, Ottawa, ON, K1P 1C3, CA

(21) Appl. No.: 11/405,592

(22) Filed: Apr. 18, 2006

Related U.S. Application Data
(60) Provisional application No. 60/672,036, filed on Apr. 18, 2005.

(51) Int. Cl. G06F 15/177

(52) U.S. Cl. 709/220

(57) ABSTRACT

A mobile application discovery system and methods for providing and obtaining information associated with mobile applications available to be downloaded to a mobile device are provided. The system comprises a publishing module for publishing a mobile application to a discovery service, a discovery module for searching a UDDI registry and a deployment descriptor for receiving and holding data in response to the inquiry. The method of providing comprises the steps of publishing mobile application information to a discovery service, receiving an inquiry for information associated with a mobile application from the discovery service and sending the information associated with the mobile application to a deployment descriptor of the discovery service in response to the inquiry. The method of obtaining mobile applications comprises the steps of searching a UDDI registry for information associated with available mobile applications, receiving the information and storing the information.

### SYSTEM AND METHOD FOR DISCOVERING COMPONENT APPLICATIONS

This non-provisional application claims benefit of U.S. Provisional Application 60/672,036 which was filed on Apr. 18, 2005, which is hereby incorporated by reference.

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

The present patent disclosure relates generally to a communication system for providing communication to a plurality of devices and specifically to a system and method for discovering component applications on such devices.

### BACKGROUND

Due to the proliferation of wireless networks, there are a continually increasing number of wireless devices in use today. These devices include mobile telephones, personal digital assistance (PDAs) with wireless communication capabilities, two-way pagers and the like. Concurrently with the increase of available wireless devices, software applications running on such devices have increased their utility. For example, the wireless device may include an application that retrieves a weather report for a list of desired cities or an application that allows a user to shop for groceries. These software applications take advantage of the ability to transmit data of the wireless network in order to provide timely and useful services to users, often in addition to voice communication. However, due to a plethora of different types of devices, restricted resources of some devices, and complexity of delivering large amounts of data to the devices, developing software applications remains a difficult and time-consuming task.

Currently, devices are configured to communicate with Web services through Internet-based browsers and/or native applications. Browsers have the advantage of being adaptable to operate on a cross-platform basis for a variety of different devices, but have a disadvantage of requesting pages (screen definitions in HTML) from the Web service, which hinders the persistence of data contained in the screens. A further disadvantage of browsers is that the screens are rendered at runtime, which can be resource intensive. Applications for browsers are efficient tools for designing platform independent applications. Accordingly, different runtime environments, regardless of the platform, execute the same application. However, since difference wireless devices have different capabilities and form factors, the application may not be executed or displayed as desired. Further, browser-based applications often require significant transfer bandwidth to operate efficiently, which may be costly or even unavailable for some wireless devices.

Universal Description, Discovery and Integration (UDDI) is a group of specifications that allow providers to publish information about their Web services and allow Web service requesters to inquire about that information to find a Web service and to be able to run the Web service. Technically, UDDI consists of an XML schema that defines four core data structures—Business, Service, Binding and Programmatic interface—and a set of APIs that operate on those structures. The architecture of UDDI allows for public and private registries. Private registries are aimed for companies offering services to trusted business associates and vendors using the services. Public registries for those offering services that are to be offered publicly in either a licensing or shareware manner. UDDI registries provide a key advantage over standard software release management practices. As new or updated versions of a Web service are released, a UDDI registry allows the service be put to use immediately by the requesting application without any recoding or reintegration work.

Wireless Mobile Applications (WMA) follow a similar paradigm. Typically, WMA offer describable services that would like to be made available either publicly or privately. WMA require a simple language agnostic protocol under which to operate using publish and inquiry methods.

UDDI specification is generic and flexible and as such requires complex interfaces. The challenge of applying UDDI in wireless space is overcoming the overhead cost incurred when transmitting large requests over slow wireless network and processing those requests on Mobile Devices with limited resources.

There is a need for a communication system for customizing component-based applications on devices to obviate or mitigate at least some of the aforementioned disadvantages.

### BRIEF DESCRIPTION OF THE DRAWINGS

An embodiment of the patent disclosure will now be described by way of example only with reference to the following drawings in which:

FIG. 1 shows in a schematic diagram a network facilitating wireless component applications;

FIG. 2 shows in a detailed component diagram the application gateway shown in FIG. 1;

FIG. 3 shows in a flow diagram a wireless component application communication model;

FIG. 4 shows in a sequence diagram of a communication sequence for the wireless component application communication model of FIG. 3;

FIG. 5 shows in an interface diagram of discovery server of FIG. 2 is shown in greater detail for discovering component applications in accordance with an embodiment of the present patent disclosure;

FIG. 6 shows in a component diagram an example of a mobile application discovery system, in accordance with an embodiment of the present patent disclosure;

FIG. 7 shows in a flowchart an example of a method of providing mobile applications, in accordance with an embodiment of the component application discovery system; and

FIG. 8 shows in a flowchart an example of a method of obtaining mobile applications, in accordance with an embodiment of the component application discovery system.

### DETAILED DESCRIPTION OF THE PREFERRED EMBODIMENT

The present patent disclosure provides for discovering component applications for a wireless device mobile services.

In accordance with an aspect of the present patent disclosure there is provided a mobile application discovery system for providing and obtaining information associated with mobile applications available to be downloaded to a mobile device. The system comprises a publishing module for publishing a mobile application to a discovery service, a discovery module for searching a UDDI registry and a deployment descriptor for receiving and holding data in response to the inquiry.

In accordance with another aspect of the present patent disclosure there is provided a method of providing mobile applications. The method comprises the steps of publishing mobile application information to a discovery service, receiving an inquiry for information associated with a mobile application from the discovery service and sending the information associated with the mobile application to a deployment descriptor of the discovery service in response to the inquiry.

In accordance with another aspect of the present patent disclosure there is provided a method of obtaining mobile applications. The method comprises the steps of searching a UDDI registry for information associated with available mobile applications, receiving the information and storing the information.

In accordance with another aspect of the present patent disclosure there is provided a computer-readable medium storing instructions or statements for use in the execution in a computer of a method of providing mobile applications. The method comprises the steps of publishing mobile application information to a discovery service, receiving an inquiry for information associated with a mobile application from the discovery service and in response to the inquiry, sending the information associated with the mobile application to a deployment descriptor of the discovery service.

In accordance with another aspect of the present patent disclosure there is provided a propagated signal carrier carrying signals containing computer-executable instructions that can be read and executed by a computer. The computer-executable instructions are used to execute a method of providing mobile applications, the method comprising the steps of publishing mobile application information to a discovery service, receiving an inquiry for information associated with a mobile application from the discovery service and in response to the inquiry, sending the information associated with the mobile application to a deployment descriptor of the discovery service.

In accordance with another aspect of the present patent disclosure there is provided a computer-readable medium storing instructions or statements for use in the execution in a computer of a method of obtaining mobile applications. The method comprises the steps of searching a UDDI registry for information associated with available mobile applications, receiving the information and storing the information.

In accordance with another aspect of the present patent disclosure there is provided a propagated signal carrier carrying signals containing computer-executable instructions that can be read and executed by a computer. The computer-executable instructions are used to execute a method of obtaining mobile applications. The method comprises the steps of searching a UDDI registry for information associated with available mobile applications, receiving the information and storing the information.

The proposed solution is to use a discovery service, which is a proxy that mediates requests between Mobile Devices and UDDI registries. The primary function of the discovery service is to wrap the complex interfaces of the UDDI registry with simplified ones that are appropriate for wireless space. To achieve consistent translation between its own interface and the corresponding UDDI interface, and vice versa, the discovery service defines a Deployment Descriptor for Mobile Applications and its mapping onto UDDI structures. The Deployment Descriptor is a collection of metadata that includes all the information required to search/provision Mobile Applications from/to Mobile Devices. The discovery service defines some additional interfaces that are beneficial in wireless space in addition to the selective set of UDDI interfaces. An example of such interface is the ‘Subscribe Notify’ interface that is used to subscribe for notifications about the availability of application upgrade or new applications. Additional interfaces will be apparent to a person of ordinary skill in the art.

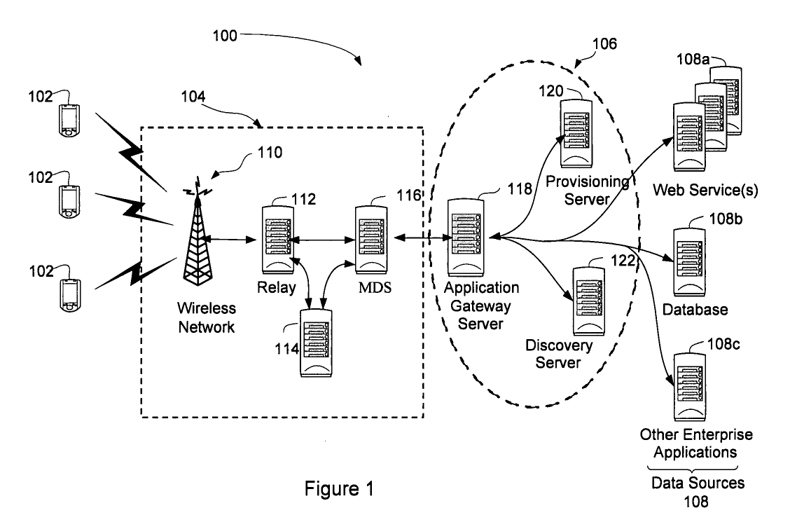

For convenience, like numerals in the description refer to like structures in the drawings. Referring to FIG. 1, a communication infrastructure is illustrated generally by numeral 100. The communication infrastructure 100 comprises a plurality of wireless devices 102, a communication network 104, an application gateway 106, and a plurality of back-end services 108.

The wireless devices 102 are typically personal digital assistants (PDAs), such as a BlackBerry™ by Research in Motion for example, but may include other devices. Each of the wireless devices 102 includes a runtime environment (RE) capable of hosting a plurality of component applications.

Component applications comprise one or more data components, presentation components, and/or message components, which are written in a structured definition language such as Extensible Markup Language (XML). The component applications can further comprise workflow components which contain a series of instructions such as written in a subset of ECMAScript, and can be embedded in the XML code in some implementations. Therefore, since the applications are compartmentalized, a common application can be written for multiple devices by providing corresponding presentation components without having to rewrite the other components. Further, large portions of the responsibility of typical applications are transferred to the runtime environment for the component application. The details of the component applications are described at the end of this description.

The wireless devices 102 are in communication with the application gateway 106 via the communication network 104. Accordingly, the communication network 104 may include several components such as a wireless network 110, a relay 112, a corporate server 114 and/or a mobile data server 116 for relaying data between the wireless devices 102 and the application gateway 106.

The application gateway 106 comprises a gateway server 118 a provisioning server 120 and a discovery server 122. The gateway server 118 acts as a message broker between the runtime environment on the wireless devices 102 and the back-end servers 108. The gateway server 118 is in communication with both the provisioning server 120 and the discovery server 122. The gateway server 118 is further in communication with a plurality of the back-end servers 108, such as Web services 108a, database services 108b, as well as other enterprise services 108c, via a suitable link. For example, the gateway server 118 is connected with the Web services 108a and database services 108b via Simple Object Access Protocol (SOAP) and Java Database Connectivity (JDBC) respectively. Other types of back-end servers 108 and their corresponding links will be apparent to a person of ordinary skill in the art.

Each wireless device 102 is initially provisioned with a service book establishing various protocols and settings, including connectivity information for the corporate server 114 and/or the mobile data server 116. These parameters may include a Uniform Resource Locator (URL) for the application gateway server 118 as well as its encryption key. Alternatively, if the wireless device 102 is not initially provisioned with the URL and encryption key, they may be pushed to the wireless device 102 via the mobile data server 116. The mobile device 102 can then connect with the application gateway 106 via the URL of the application gateway server 118.

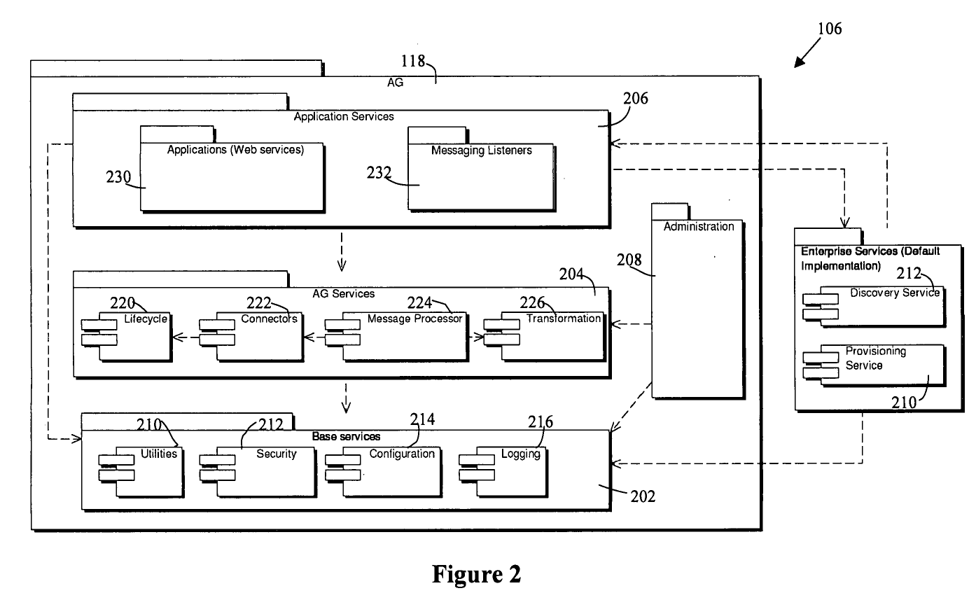

Referring to FIG. 2, a more detailed view of the application gateway 106 is shown. The application gateway server 118 includes three layers of service: a base services layer 202, an application gateway services layer 204 and an application services layer 206. The application gateway server 118 further includes an administration service 208.

A provisioning service 210 and a discovery service 212 are provided by the provisioning server 120 and discovery server 120, respectively.

At the lowest level, the base services layer 202 offers basic, domain-independent system services to other components in higher levels. Thus, for example, all subsystems in the application gateway services layer 204 and the application services layer 206 can utilize and collaborate with the subsystems in the base services layer 202. In the present embodiment, the base services layer 202 includes a utilities subsystem 210, a security subsystem 212, a configuration subsystem 214, and a logging subsystem 216.

The application gateway services layer 204 provides wireless component application domain-specific services. These services provide efficient message transformation and delivery to back-end services 108 and provide wireless device 102 and component application lifecycle management. In the present embodiment, the application gateway services layer 204 includes a lifecycle subsystem 220, a connector subsystem 222, a messaging subsystem 224, and a transformation subsystem 226.

The application services layer 206 sits at the top of the architecture and provides external program interfaces and user interfaces using subsystems provided by the lower layers. For example, various applications such as a service provider lifecycle application, a packaging application and a message listening application provide external program interfaces since they communicate primarily with applications on external systems. Similarly, an administration application provides a user interface by providing a user with the ability to access and potentially modify application gateway data and/or parameters.

The administration service 208 is responsible for administrative system messages, administration of the wireless devices 102, runtime administration of the application gateway subsystems, support and display system diagnostics, and administration of default implementations of the provisioning and discovery services.

The messaging listening application provides an interface for receiving messages from the wireless devices 102 as well as external sources and forwarding them to the messaging subsystem. Further, the message listening application typically authenticates that the source of the message is valid.

The security subsystem 212 providing services used by other subsystems for securing communications with the wireless device 102. In order to facilitate secure communications, the security subsystem 212 encrypts and decrypts messages, validates signatures and signs messages.

Referring to FIG. 3 there is illustrated in a flow diagram a wireless component application communication model. From a high-level perspective, the overall wireless component application infrastructure 300 includes a wireless component application runtime environment (Device RE) running on the device 102 and a wireless component application gateway (AG) 106 running on the server 118.

The AG 106 serves as a mediator between a wireless component application (sometimes referred to as application in this disclosure) executed by the RE and one or more back-end services 108 with which the application communicates. Often the back-end service is expected to be a Web service 108a using SOAP over HTTP or HTTPS as the transport protocol. As Web services are the most commonly expected back-end service 108, the term Web service is used interchangeable with back-end service 108 throughout this disclosure. However, it is appreciated that other types of back-end services can also be adapted to the disclosure. FIG. 3 exemplifies a synchronous link with a back-end service 108. However, it should be appreciated that the AG 106 can be in communication with back-end services 108 over asynchronous links.

The wireless component application communication model 300 is based upon an asynchronous messaging paradigm. In this model the application gateway (AG) 106 establishes and mediates the connection between the device 102 and the back-end service(s) 108 to:
1. Achieve greater flexibility in resource management.
2. Provide reliable communication link between the device 102 and the back-end service 108 to handle situations when wireless coverage is unstable.
3. Efficiently distribute workload between the device RE 102 and the AG 106.

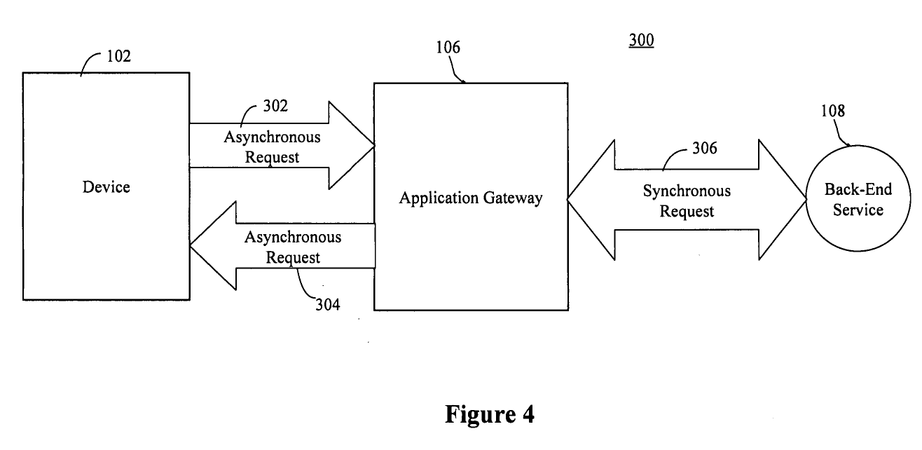

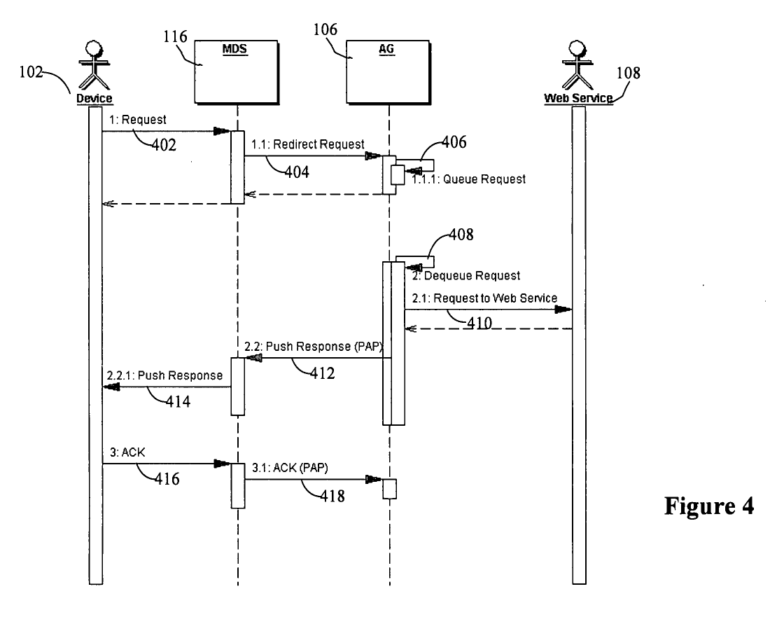

Referring to FIG. 4 there is illustrated in a sequence diagram a communication sequence for the wireless component application communication model of FIG. 3. The diagram describes the communications sequence between the device 102 and the back-end service(s) 108:
Upon receiving a request 402 from the device 102, via 404 MDS 116, AG 106 queues the request 406 and releases the connection to the device.
Next, the request is retrieved from the queue 408, pre-processed and forwarded 410 to the Web service 108 through a synchronous communication channel.
Any response from the previous request is processed by the AG 106 and a response message is sent asynchronously 412 and 414 back to the device.

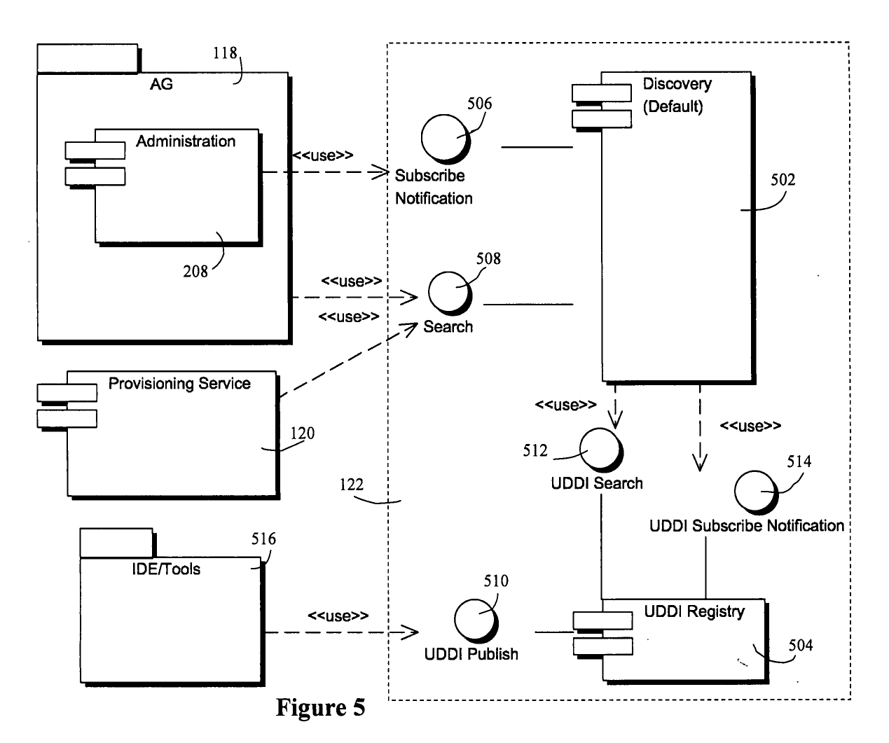

Referring to FIG. 5, an interface diagram of a discovery server of FIG. 2 is shown in greater detail for discovering component applications, in accordance with an embodiment of the present patent disclosure. The discovery service 502 can be configured to be in communication with a plurality of registries that implement the UDDI specification.

Given its purpose the discovery service 502 is readily accessible over the network via a standardized protocol. In the preferred embodiment the discovery service 502 is implemented as a Web service, however other implementations will be apparent to a person of ordinary skill in the art.

In another embodiment, a default security mechanism of the discover service 502 delegates all authentication requests to the target UDDI registry.

Referring to FIG. 5, the discovery server 122 is shown in greater detail. The discover server 122 comprises a discovery service 502 and a Universal Description, Discovery and Integration (UDDI) registry 504. The discovery service 502 communicates with the UDDI registry 504 via a UDDI search interface 512 and a UDDI subscription notification interface 514. The discovery service 502 further communicates with the administration subsystem server 208 via a subscription notification interface 506, and with both the application gateway server 118 and the provisioning server 120 via a search interface 508. The UDDI registry 504 is in communication with an integrated development enterprise (IDE) 516 via a UDDI publish interface 510.

The UDDI publish interface 510 is a SOAP-based UDDI interface providing publishing capabilities. This interface is used by any utility that facilitates component application publishing. Accordingly, once a developer has created a component application, it can be submitted to the UDDI registry 504 by following a set of component application publication rules.

The discovery service 502 can request a notification of new or updated component applications registered with the UDDI registry 504. The UDDI subscription notification interface 514 is a SOAP-based UDDI interface provided by UDDI registry to subscribe for Registry notifications. Preferably, the support for notification is based on the UDDI v3.0 specification.

The UDDI search interface 512 provides a SOAP-based UDDI interface for searching the UDDI registry.

The default implementation of the discovery service 502 is a standalone Web service deployed as part of the application gateway 106 via the discovery server 122. The discovery service 502 offers local component application discovery services to a discovery component application on the runtime environment on the wireless devices 102. From the perspective of the application gateway server 118, the discovery service 502 is a typical component application, and is deployed and managed as such. Accordingly, processing of discovery messages is generic and transparent to the application gateway server. Thus, the application gateway server 118 serves as a message broker between the runtime environment and the discovery service 502.

Typically, the runtime environment communicates with the discovery service 502 through the search interface 508. The current search interface 508 may be replaced with another one, as long as both the discovery component application on the wireless device and the discovery service 502 support the replacement search interface.

Yet further, the default implementation of the discovery service 502 may be used to enforce the secure wireless component provisioning policy. The security is achieved since the discovery service 502 accesses only predefined local or trusted UDDI registries.

Similarly to the UDDI subscription notification interface 514, the subscription notification interface 506 is a SOAP-based interface implemented by the discovery service provider 122. The subscription notification interface 506 allows the administration subsystem 208 to subscribe for discovery notifications. Such notifications include, for example, ‘new component application version is available’ and ‘new component application is available’.

The following terms are used in this patent disclosure:

| | |
|---|---|
| UDDI | Universal Description, Discovery and Integration. |
| Web service | A software system identified by a Uniform Resource |
| | Interface (URI), whose public interfaces and bindings are |
| | defined and described using XML. |
| XML | Extensible Markup Language |
| DD | Deployment Descriptor |

FIG. 6 shows in a component diagram an example of a mobile application discovery system 600 for providing and obtaining mobile applications, in accordance with an embodiment of the present patent disclosure. The mobile application discovery system 600 comprises a publishing module 602 for publishing a mobile application to a discovery service 502 acting as a wrapper to the UDDI registry 504, a discovery module 604 for searching the UDDI registry by calling an inquiry on the discovery service 502 and a deployment descriptor 606 for receiving and holding data in response to the inquiry. Other components may be added to the mobile application discovery system 600, including a development toolkit for assisting in the development of mobile applications.

The following describes a typical scenario that can occur with the mobile component discovery system:
1. A developer develops a mobile application using a development toolkit.
2. The developer or a publisher then uses the publishing module 602 to publish the mobile application to a discovery service 502 acting as a wrapper to the UDDI registry 504.
3. Wireless device users can use the discovery module 604 to search the UDDI registry by calling a UDDI inquiry on the discovery service hosting the UDDI registry. A back-end end service 108 receives the inquiry parameters (654).
4. The wireless users receive the appropriate data in the deployment descriptor 606 in response to the UDDI inquiry. The data will assist the user to determine if they would like to install or upgrade to available entries in the UDDI registry using a separate provisioning application also hosted on the device 102.

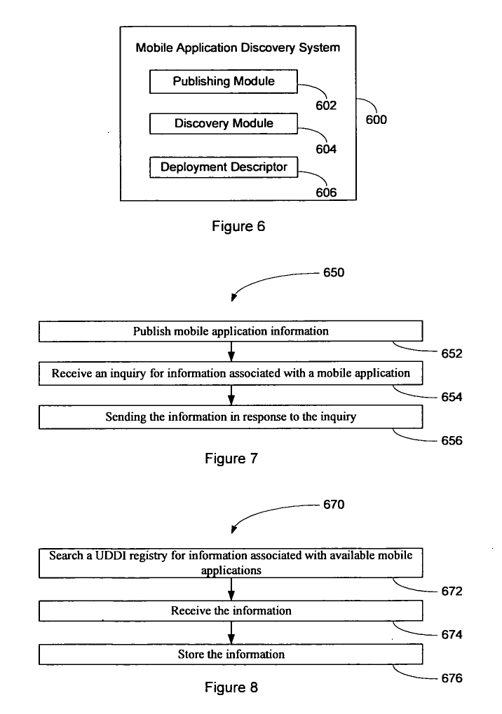

FIG. 7 shows in a flowchart an example of a method of providing mobile applications (650), in accordance with an embodiment of the component application discovery system 600. The method (650) begins with publishing mobile application information to a discovery service (652). Next a UDDI inquiry for information associated with a mobile application is received from the discovery service (654). In response to the UDDI inquiry, the information associated with the mobile application is sent to a deployment descriptor of the discovery service (656).

FIG. 8 shows in a flowchart an example of a method of obtaining mobile applications (670), in accordance with an embodiment of the component application discovery system 600. The method begins with searching a UDDI registry for information associated with available mobile applications (672). The information is received (674) and stored (676).

Wireless mobile applications are mapped to the UDDI. Table A, below, shows three major metadata groupings containing wireless mobile applications and their descriptions:

TABLE A

| | |
|---|---|
| Application | The Application Publisher is an example of a |
| Publisher | publishing module 602 that publishes application |
| | related information. The Application Publisher is |
| | not necessarily the originator of the application, |
| | but rather the party responsible for actually making |
| | the application available and responsible for its |
| | outcomes. The Application Publisher is also |
| | responsible for any type of trusted signing of the |
| | applications via digital signatures. |
| Application | The Application Suite comprises descriptive |
| Suite | information about a particular family, group or |
| | composite of applications that may or may not share |
| | a similarity about how they are related. |
| Application | This grouping comprises the technical information |
| | about a particular Application and its |
| | implementation details. |

A deployment descriptor 606 is a container used to hold wireless mobile application data. This data is mapped into the various UDDI data structure objects which are then stored in the UDDI registry. The following is an example of a description of the deployment descriptor information:
Deployment Descriptor (DD)
Application URI
Application name
Version
Vendor
Description
Size
Type
Install Notify URL
Application (jar) URL
Dependencies
Supported languages
Target folder
Dedicated Server URL

Table B, below, shows three mappings from the major metadata groupings in a wireless mobile application to UDDI objects. The wireless mobile application entities are mapped to UDDI objects as shown in Table B.

TABLE B
Mappings

| Wireless Mobile Application | UDDI Object |
|---|---|
| Application Publisher | Business Entity |
| Application Suite | Business Service |
| Application | Binding Template |

571 Table C, below, shows an example of a description of UDDI structures of a business entity UDDI object and their corresponding detailed application information.

TABLE C
businessEntity

| UDDI Structure | Application infomation |
|---|---|
| uddi:discoveryURLs | Optional. |
| uddi:name | Application Publisher name. This value |
| | is extracted from the DD, where it is stored |
| | as vendor name. Since the vendor name is an |
| | optional property, a default public publisher |
| | should be used if the vendor name is not |
| | specified in the DD. |
| uddi:description | The description of the Application Publisher. |
| uddi:contacts | The contact information for Application |
| | Publisher. |
| uddi:businessServices | List of Application Suites published by this |
| | Application Publisher. |
| uddi:identifierBag | A list of identifiers describing the |
| | Application Publisher. |
| uddi:categoryBag | A list of categories describing the Application |
| | Publisher. |
| dsig:Signature | Security digital signature for the application. |

Table D, below, shows an example of a description of UDDI structures of a business service UDDI object and their corresponding detailed application information:

TABLE D
businessService

| UDDI Structure | Application information |
|---|---|
| uddi:name | The name of the Application Suite. |
| uddi:description | The description of the Application Suite. |
| uddi:bindingTemplates | A list of Applications implementing in this |
| | Application Suite. |
| uddi:categoryBag | A list of categories describing the Application |
| | Suite. The categories include: Application Suite |
| | type: Business Application, Information |
| | Service, Game, etc. |
| dsig:Signature | Security digital signature for the application. |

Table E, below, shows an example of a description of UDDI structures of a binding template UDDI object and their corresponding detailed application:

TABLE E
bindingTemplate

| UDDI Structure | Application infomation |
|---|---|
| uddi:description | The description of the Application |
| | (from DD). |
| uddi:accessPoint | The URL of the Application bundle. |
| | Need to define a new useType. |
| uddi:hostingRedirector | Transport redirection information |
| | for the mobile application. |
| uddi:tModelInstanceDetails | The name-value pairs of Deployment |
| | Descriptor that do not map to any UDDI |
| | data structures are embedded in an XML |
| | document and stored as part of instance |
| | details. A custom tModel is created for |
| | such purpose. The cost model and charges. |
| | Need to define a new tModel. |
| uddi:categoryBag | A list of categories describing the |
| | Application: |
| | Application URI |
| | Application version |
| | Application name |
| | General keywords |
| dsig:Signature | Digital signature over the bindingTemplate |
| | and its children (including over data referred |
| | by tModels). |

Table F, below, shows an example of a business entity and its corresponding application information. Preferably, the following UDDI tModels are created to support application mapping onto the UDDI registry:

TABLE F
tModels

| Suggested | Suggested UDDI | |
|---|---|---|
| tModel Name | tModel key | Description |
| Application | uddi:rim.com:categorization | Specifies Application URI. |
| URI | :wiclet:uri | Used in the category bag |
| | | of bindingTemplate. |
| Application | uddi:rim.com:categonzation | Specifies Application |
| version | :wiclet:version | version. Used in the |
| | | category bag of |
| | | bindingTemplate. |
| Application | uddi:rim.com:categorization | Specifies wireless |
| name | :wiclet:name | component application |
| | | name. Used in the category |
| | | bag of bindingTemplate. |
| Mobile | uddi:rim.com:categorization | Specifies the set of name- |
| Application | :wiclet:prop | value pairs defined by the |
| properties | | deployment descriptor that |
| | | do not map to any UDDI |
| | | structures. Used in the |
| | | tModelInstanceInfo of |
| | | bindingTemplate. |
| Mobile | uddi:rim.com:categorization | Specifies a wireless |
| Application | :wicletsuite:type | component application |
| Suite | | Suite type. Used in the |
| Category | | category bag of |
| | | businessService. |
| Bundle URL | uddi:rim.com:categorization | Specifies a custom |
| | :mobileapplication:url | “useType” for |
| | | accessPoint of |
| | | bindingTemplate that |
| | | defines a wireless |
| | | component application. |
| | | This useType specifies |
| | | the bundle URL location. |

The mobile application discovery system 600 and methods according to the present patent disclosure may be implemented by any hardware, software or a combination of hardware and software having the above described functions. The software code, either in its entirety or a part thereof, may be stored in a computer-readable memory. Further, a computer data signal representing the software code which may be embedded in a carrier wave may be transmitted via a communication network. Such a computer-readable memory and a computer data signal are also within the scope of the present patent disclosure, as well as the hardware, software and the combination thereof.

While particular embodiments of the present patent disclosure have been shown and described, changes and modifications may be made to such embodiments without departing from the true scope of the patent disclosure.

What is claimed is:

1. A mobile application discovery system for providing and obtaining information associated with mobile applications available to be downloaded to a mobile device, the mobile application discovery system comprising:
a publishing module for publishing a mobile application to a discovery service;
a discovery module for searching a UDDI registry; and
a deployment descriptor for receiving and holding data in response to the inquiry.

2. The system as claimed in claim 1, wherein the deployment descriptor stores mobile application information associated with one or more of:
Application URI;
Application name;
Version;
Vendor;
Description;
Size;
Type;
Install Notify URL;
Application (jar) URL;
Dependencies;
Supported languages;
Target folder; and
Dedicated Server URL.

3. The system as claimed in claim 1, further comprising a development toolkit for assisting in the development of mobile applications.

4. The system as claimed in claim 1, wherein the mobile application is a Web service.

5. The system as claimed in claim 1, wherein the mobile application is a database service.

6. The system as claimed in claim 1, wherein the mobile application is an enterprise service.

7. The system as claimed in claim 1, further comprising:
an application gateway server including a message broker for communicating with a plurality of mobile devices, the application gateway server configured for communication with a back-end service and a discovery server providing mobile applications the mobile device; and
a discovery server for hosting the mobile application discovery system.

8. A method of providing mobile applications, the method comprising the steps of:
publishing mobile application information to a discovery service;
receiving an inquiry for information associated with a mobile application from the discovery service; and
in response to the inquiry, sending the information associated with the mobile application to a deployment descriptor of the discovery service.

9. A method of obtaining mobile applications, the method comprising the steps of:
searching a UDDI registry for information associated with available mobile applications;
receiving the information; and
storing the information.

10. A computer-readable medium storing instructions or statements for use in the execution in a computer of a method of providing mobile applications, the method comprising the steps of:
publishing mobile application information to a discovery service;
receiving an inquiry for information associated with a mobile application from the discovery service; and
in response to the inquiry, sending the information associated with the mobile application to a deployment descriptor of the discovery service.

11. A propagated signal carrier carrying signals containing computer-executable instructions that can be read and executed by a computer, the computer-executable instructions being used to execute a method of providing mobile applications, the method comprising the steps of:
publishing mobile application information to a discovery service;
receiving an inquiry for information associated with a mobile application from the discovery service; and
in response to the inquiry, sending the information associated with the mobile application to a deployment descriptor of the discovery service.

12. A computer-readable medium storing instructions or statements for use in the execution in a computer of a method of obtaining mobile applications, the method comprising the steps of:
searching a UDDI registry for information associated with available mobile applications;
receiving the information; and
storing the information.

13. A propagated signal carrier carrying signals containing computer-executable instructions that can be read and executed by a computer, the computer-executable instructions being used to execute a method of obtaining mobile applications, the method comprising the steps of:
searching a UDDI registry for information associated with available mobile applications;
receiving the information; and
storing the information.
